(19) United States
(12) Patent Application Publication
(10) Pub. No.: US 2005/0265126 A1
(43) Pub. Date: Dec. 1, 2005

(54) RANDOM NUMBER INITIAL VALUE GENERATION DEVICE AND METHOD, RANDOM NUMBER INITIAL VALUE GENERATION PROGRAM

(75) Inventors: Makoto Izawa, Tokyo (JP); Hiromitsu Narita, Tokyo (JP); Akira Okamoto, Ageo-shi, (JP)

Correspondence Address: CONNOLLY BOVE LODGE & HUTZ LLP, SUITE 800, 1990 M STREET NW, WASHINGTON, DC, 20036-3425, US

(73) Assignees: MICRO RESEARCH LABORATORY, INC., Tokyo (JP); NIIGATA SEIMITSU CO., LTD., Jyoetsu-shi (JP)

(21) Appl. No.: 10/711,811

(22) Filed: Oct. 6, 2004

Related U.S. Application Data
(63) Continuation of application No. PCT/JP03/05268, filed on Apr. 24, 2003.

(30) Foreign Application Priority Data
May 9, 2002 (JP) 2002-134682

(51) Int. Cl. G04B 47/00

(52) U.S. Cl. 368/10

(57) ABSTRACT

A device is provided with: a counter 11 for measuring a period of time from turning on an electronic apparatus 1 to receiving via a network 3 a first network event that occurs after turning on the electronic apparatus 1; and a value determining section 12 for determining a value of an initial random number on the basis of the time information obtained by the counter 11. In this device, an initial random number for random numbers is generated utilizing the fact that the first network event is received in a “random” period of time after turning on the electronic apparatus 1. In addition, since existing electronic apparatuses are generally provided with various devices including the counter 11 and a CPU with the value determining section 12, an initial random number for random numbers can be generated utilizing an existing hardware configuration.

### CROSS REFERENCE TO RELATED APPLICATIONS

This application is a Continuation of International Application PCT/JP03/05268 filed on Apr. 24, 2003. International Application PCT/JP03/05268 claims priority from Japanese Application 2002-134682 filed on May 9, 2002, the entire contents of each of which are incorporated herein by reference.

### FIELD OF THE INVENTION

The present invention relates to a random number initial value generation device and method, a random number initial value generation program. In particular, the present invention relates to a device, a method and a program which are preferably used in determining an initial random number for random numbers on electronic apparatuses which can be connected to networks and which have no inputting devices such as a keyboard and a mouse as well as no absolute-time measuring clocks.

### BACKGROUND OF THE INVENTION

Security techniques such as the setting of a variable password, the encryption of data, and the use of an electronic signature are used to protect from eavesdropping, alteration, destruction, or the like of data caused by unauthorized person's entries and attacks. In these security techniques, random numbers are utilized in order to generate a random password or an encryption key as required. To generate random numbers, an initial number thereof must first be determined. Therefore, to allow each of the random numbers to have a truly random value, the “initial” number thereof must have a truly random value.

Conventionally, in the case where an initial value of random numbers is to be determined on a PC (Personal Computer), a user interface such as a keyboard or a pointing device (e.g., mouse) is utilized, for example. In this method, the initial number having a random value is generated on the basis of inputted data such as: data that is inputted therein when a user presses a key(s) of the keyboard at random; and data that is inputted therein when a user moves the pointing device in a random manner. Further, in another method, the initial number value of random numbers is determined on the basis of time data at the time when a PC is tuned on.

However, existing electronic apparatuses also include apparatuses having no absolute-time measuring clock as well as no user interface for the connection of devices such as a keyboard and a pointing device. On such a type of electronic apparatuses, the methods as described above cannot be used in order to generate the initial number of random numbers. For example, some of electronic apparatuses that can be connected to a network are actually provided with no user interface as well as no clock. Thus, in the case of a system including such electronic apparatuses with no user interface as well as no clock, other methods have to be used in order to provide random numbers to these electronic apparatus.

For the reasons described above, the following methods have been produced. In one of such methods, an LSI for dedicatedly generating an initial number of random numbers is prepared, and an electronic apparatus is provided with such an LSI. In the other method, a volatile memory provided in an electronic apparatus is utilized in order to generate an initial number of random numbers. In more detail, since the volatile memory has an indefinite value at the time when the electronic apparatus is turned on, according to this method the initial number can be generated on the basis of such an indefinite value.

However, the method of using the dedicated LSI has a problem in that the cost of the electronic apparatus is increased for the LSI. Further, the method of utilizing a value of the volatile memory also has a problem in that truly random numbers cannot be generated. This is because a value of the volatile memory is indefinite but not random, and therefore the electronic apparatus in this case often generates the initial number with a regular tendency.

### SUMMARY OF THE INVENTION

In view of the above, it is an object of the present invention to allow an electronic apparatus having no user interfaces as well as no clock to generate an initial random number for random numbers, without any increases in costs associated with the use of a dedicated LSI or the like.

In order to achieve the above object, the present invention is directed to a random number initial value generation device, the device being able to be used in an electronic apparatus that is to be connected to a network, the device comprising: time measuring means for measuring a period of time from turning on the electronic apparatus to receiving a network event via the network, so that time information for the period of time is obtained; and value determining means for determining a value of the initial random number on the basis of the time information obtained by the time measuring means.

In another aspect of the present invention, the time measuring means measures the period of time from turning on the electronic apparatus to receiving via the network a first network event that occurs after turning on the electronic apparatus.

Further, in another aspect of the present invention, the value determining means includes calculating means for executing a predetermined calculation on the time information obtained by the time measuring means, so that the value of the initial random number is determined.

Further, in another aspect of the present invention, the device further comprises storage means for storing the determined value of the initial random number, wherein next time the electronic apparatus is turned on, the calculating means executes the predetermined calculation on said determined value stored in the storage means, so that the value of the initial random number is determined in the next time.

In order to achieve the above object, the present invention is also directed to a random number initial value generation method, the method being performed on an electronic apparatus that is to be connected to a network, the method comprising the steps of: measuring a period of time from turning on the electronic apparatus to receiving a network event via the network, so that time information for the period of time is obtained; and determining a value of the initial random number on the basis of the obtained time information.

Further, in order to achieve the above object, the present invention is also directed a random number initial value generation program, the program being able to be executed in an electronic apparatus that is to be connected to a network, and the program allowing the electronic apparatus to function as: time measuring means for measuring a period of time from turning on the electronic apparatus to receiving a network event via the network, so that time information for the period of time is obtained; and value determining means for determining a value of the initial random number on the basis of the time information obtained by the time measuring means.

### BRIEF DESCRIPTION OF THE DRAWINGS

FIG. 1 is a block diagram showing an example of an arrangement of essential parts of an electronic apparatus, in which a random number initial value generation device according to the embodiment is used;

FIG. 2 is a diagram showing an example of configuration of a network system where the electronic apparatuses in FIG. 1 are applied; and

FIG. 3 is a flow chart showing an operation for generating a random number initial value according to the embodiment.

### DETAILED DESCRIPTION OF THE PREFERRED EMBODIMENTS

An embodiment of the present invention will be described below with reference to the drawings.

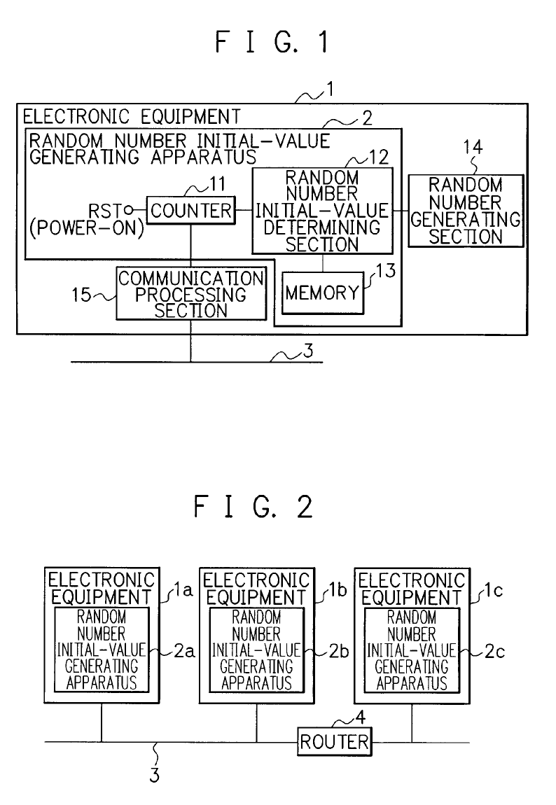

FIG. 1 is a block diagram showing an example of an arrangement of essential parts of an electronic apparatus, where a random number initial value generation device according to the present embodiment is used. Hereinafter, the random number initial value generation device is referred to simply as an “initial-number generator”. FIG. 2 is a diagram showing an example of entire configuration of a network system where the electronic apparatuses in FIG. 1 are applied.

As shown in FIG. 2, the electronic apparatuses 1a, 1b and 1c are provided with initial-number generators 2a, 2b and 2c of this embodiment, respectively. The electronic apparatuses 1a, 1b and 1c are connected to a network 3 via a router 4, so that each electronic apparatus can transmit/receive data to/form the other electronic apparatus.

As shown in FIG. 1, the electronic apparatus 1 of this embodiment has a random-numbers generator (random numbers generating section) 14 and a communications processor (communications processing section) 15 in addition to the initial-number generator 2. The initial-number generator 2 has a counter 11; a value determining section 12; and a memory 13. The communications processor 15 executes predetermined processes, so that each electronic apparatus 1 with the communications processor 15 can perform data communications with the other electronic apparatus on the network 3 via the router 4.

When the electronic apparatus 1 has been turned (powered) on, the counter 11 is initialized to reset its count to “zero”, and then a time counting operation is started. Thus, the counter 111 measures a period of time from turning on the electronic apparatus 1 to receiving a network event from the network 3 via the communications processor 15 thereof. (Examples of such a period of time include: a period of time from the turning-on to receiving meaningful data such as a data packet or a token; and a period of time from the turning-on to receiving a signal that has no special meaning.)

In this case, any of the network events occurring after the electronic apparatus 1 has been turned on may be used by the counter 11 as a trigger for stopping the time counting operation. However, a network event that occurs earlier after the time counting operation has been started is preferably used. In particular, a “first” network event that occurs after turning on the electronic apparatus 1 is more preferably used. By using a network event that occurs earlier after turning on the electronic apparatus 1, it becomes possible to reduce a response time that is required until random numbers become available after turning it on.

The value determining section 12 determines a value of an initial random number for random numbers, on the basis of the time count measured by the counter 11. In this connection, the value of the measured time count may be determined (used) as a value of an initial random number. Alternatively, a predetermined calculation may be executed on the measured time count to determine a value of an initial random number. In the case of executing such a predetermined calculation, the value determining section 12 mentioned above has to be provided with a CPU (which corresponds to calculating means of the claimed invention). It should be noted that various patterns of algorithms are available for calculating a value of an initial random number. In addition, in this invention, the algorithm for this calculation is not particularly limited, and any calculation patterns may be used.

The value of the initial random number determined by the value determining section 12 is stored on the memory 13. The memory 13 is provided with, for example, a non-volatile recording medium. Instead of such a non-volatile memory, the initial-number generator 2 may be provided with the memory 13 that includes both of a volatile recording medium and backup batteries (or the like) for preventing stored information from being lost when turning off the electronic apparatus 1.

The information stored in the memory 13 is used by the value determining section 12 next time the electronic apparatus 1 is turned on, so that a value of a new initial random number to be used in the next time is calculated on the basis of the initial random number value calculated at the last time. In more detail, when the electronic apparatus 1 is turned on for the first time, a value of an initial random number is determined on the basis of the time count measured by the counter 11. Upon and after the second turning-on operation, a value of a new initial random number is calculated on the basis of the initial random number value that has been stored in the memory 13 through the calculation at the last time, and then the calculated value of the new initial random number is stored in the memory 13.

In this connection, the initial-number generator 2 may be provided with no memory 13. In this case, a value of an initial random number for random numbers may be determined on the basis of the time count measured by the counter 111 every time the electronic apparatus 1 is turned on.

The random-numbers generator 14 executes a predetermined calculation on the initial random number value produced in the way described above, so that random numbers are generated. In this connection, various patterns of algorithms are available for generating the random numbers, and various methods thereof have been proposed. In the present embodiment, any of such well-known methods is applicable.

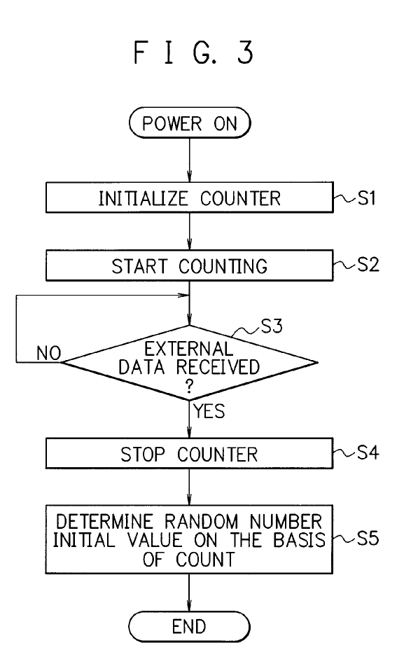

Next, with reference to the flow chart in FIG. 3, description will be given for an operation when generating a random number initial value using the initial-number generator of this embodiment.

When the electronic apparatus 1 is turned on, the counter 111 is initialized to reset its count to “zero” (Step S1), and then a time counting operation is started (Step S2).

Then, it is determined whether or not a first network event (e.g., data such as a data packet) has been received from the network 3 via the communications processor 15 (Step S3). In the case where such a network event has not yet been received, the time counting operation by the counter 11 is continued to make its count up.

On the other hand, in the case where it is judged at Step S3 that the first network event has been received, the time counting operation by the counter 11 is stopped (Step S4). Then, on the basis of the time count at this time, the value determining section 12 determines a value of an initial random number (Step S5).

As described above in detail, this embodiment utilizes the fact that a first event is received in a “random” period of time after turning on the electronic apparatus 1. Therefore, according to the method described above, even in electronic apparatuses that have no user interface such as a keyboard and a pointing device as well as no absolute-time measuring clock, it is possible to generate an initial random number having a “random” value, without any increases in costs associated with the use of a dedicated LSI. In addition, since a counter 11 and a CPU with an initial number determining section 12 as described above are generally provided in electronic apparatuses 1, an initial random number can be generated utilizing an existing hardware configuration.

The initial-number generator of this embodiment can be used in various systems. For example, it may be used in electronic apparatuses on a network that utilizes random numbers to generate variable passwords and/or encryption keys. In this regard, a server that is externally connected to an electronic apparatus via a network can be used in generating and providing a value for an initial random number in response to a request from this electronic apparatus. However, in this case, since the value generated on the server is transmitted and received in the form of a plain text before encrypted data communications are started, the initial random number is likely to be eavesdropped to decrypt the encryption key. On contrast with this case, in the present embodiment, the electronic apparatus provided with the initial-number generator “internally” generates an initial random number for random numbers. Consequently, the value of an initial random number is unlikely to be eavesdropped, thus enabling secure encrypted communication.

Further, the initial-number generator of the present embodiment is applicable to a system in which master apparatus sets addresses for plural pieces of slave apparatus connected to a network. For example, when a DSU (Digital Service Unit) as a master sets different addresses for a plurality of TAs (Terminal Adapters) as slaves, each of the TAs must generate and report a random value to the DSU. In this case, the initial-number generator of this embodiment is applicable to each TA.

For the communication between the DSU and the TAs, even if a plurality of TAs report the same address, the DSU can feed this back to the TAs to have the TAs report their new addresses. Then, consequently, different addresses can be set for all TAs. However, if an initial number for random numbers is generated using a value from a volatile memory as in the case with the prior art, then it is more likely that a plurality of TAs report the same address. Accordingly, they must repeat reporting their new addresses many times. As opposed to this, according to the present embodiment, it is more probable that single reporting enables different addresses to be set for the plurality of TAs. This reduces the time elapsing after power-on and before the system starts to operate.

The method for generating an initial random number for random numbers according to the present embodiment described above can be carried out using any of a hardware configuration, a DSP, and software. For example, in the case of achieving this invention using software, the initial-number generator of this embodiment is actually provided with a CPU (or MPU), a RAM, a ROM and the like in a computer existing in the electronic apparatus 1. By running an initial number generating program stored in the RAM or ROM, the generation of an initial number of random numbers can be achieved.

Therefore, the generation of an initial random number for random numbers can be achieved by installing the initial number generating program onto the electronic apparatus 1. Such an initial number generating program may be recorded on a recording medium such as a CD-ROM. Besides the CD-ROM, a flexible disk, a hard disk, a magnetic tape, an optical disk, a photomagnetic disk, a DVD, a nonvolatile memory card, or the like may also be used as such a recording medium for storing the initial number generating program. Alternatively, in order to achieve the generation of the initial random number, the initial number generating program may also be downloaded to the electronic apparatus 1 via a network such as the Internet.

The above-mentioned embodiment according to the present invention is just one of examples of this invention, and the scope of invention is not limited to the embodiment. Therefore, various modifications and changes can be made without departing from the spirit and the scope of the invention.

According to the present invention described above, the device for generating an initial random number measures a period of time from turning on its electronic apparatus to receiving a network event via a network. Then, it determines a value of an initial random number on the basis of this time information. This manner allows an electronic apparatus having no user interfaces as well as no clock to generate an initial random number for random numbers, without any increases in costs associated with the use of a dedicated LSI or the like.

### INDUSTRIAL APPLICABILITY

The present invention is preferably used in allowing an electronic apparatus having no user interfaces as well as no clock to generate an initial random number for random numbers, without any increases in costs associated with the use of a dedicated LSI or the like.

1. A random number initial value generation device, the device being able to be used in an electronic apparatus that is to be connected to a network, the device comprising:
time measuring means for measuring a period of time from turning on the electronic apparatus to receiving a network event via the network, so that time information for the period of time is obtained; and
value determining means for determining a value of the initial random number on the basis of the time information obtained by the time measuring means.

2. The device according to claim 1, wherein the time measuring means measures the period of time from turning on the electronic apparatus to receiving via the network a first network event that occurs after turning on the electronic apparatus.

3. The device according to claim 1, wherein the value determining means includes calculating means for executing a predetermined calculation on the time information obtained by the time measuring means, so that the value of the initial random number is determined.

4. The device according to claim 3, further comprising storage means for storing the determined value of the initial random number,
wherein next time the electronic apparatus is turned on, the calculating means executes the predetermined calculation on the determined value stored in the storage means, so that the value of the initial random number is determined in the next time.

5. Random number initial value generation method, the method being performed on an electronic apparatus that is to be connected to a network, the method comprising the steps of:
measuring a period of time from turning on the electronic apparatus to receiving a network event via the network, so that time information for the period of time is obtained; and
determining a value of the initial random number on the basis of the obtained time information.

6. Random number initial value generation program, the program being able to be executed in an electronic apparatus that is to be connected to a network, and the program allowing the electronic apparatus to function as:
time measuring means for measuring a period of time from turning on the electronic apparatus to receiving a network event via the network, so that time information for the period of time is obtained; and
value determining means for determining a value of the initial random number on the basis of the time information obtained by the time measuring means.
